(19) United States
(12) Patent Application Publication
(10) Pub. No.: US 2010/0239845 A1
(43) Pub. Date: Sep. 23, 2010

(54) THERMOPLASTIC RESIN COMPOSITION FOAMED SHEET AND METHOD FOR PRODUCING THE SAME

(76) Inventors: Tomofumi Maekawa, Tokyo (JP); Katsuhiro Fujimoto, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/442,974

(22) PCT Filed: Sep. 26, 2007
(86) PCT No.: PCT/JP2007/068605

§ 371 Date: Mar. 2, 2010

(30) Foreign Application Priority Data
Sep. 29, 2006 (JP) P2006-267290
Sep. 29, 2006 (JP) P2006-267295

(51) Int. Cl. B32B 3/26; B29C 44/12

(52) U.S. Cl. 428/315.7; 264/45.3

(57) ABSTRACT

The present invention takes as its object the provision of a thermoplastic resin foamed sheet having excellent surface exterior appearance, lightweightness, PTT property and light reflectivity and the provision of a method for producing the thermoplastic resin foamed sheet. Specifically, the thermoplastic resin foamed sheet is a foamed sheet including 80 to 99.5% by weight of an (A) thermoplastic resin and 0.5 to 20% by weight of (B) PTFE (polytetrafluoroethylene), wherein when in the foamed sheet interior observed with a SEM (scanning electron microscope), the number of the particles of (B) PTFE having a dispersed particle size falling within a range from 0.05 to 1 μm is represented by (L), the number of the particles of (B) PTFE having a dispersed particle size falling within a range from 1 to 30 μm is represented by (M) and the number of the particles of (B) PTFE having a dispersed particle size falling within a range of 30 μm or more is represented by (N), (L)/(M)=99.99/0.01 to 50/50, and (M)>(N); and the average bubble size in the direction normal to the take-off direction of the foamed sheet is 0.1 to 50 μm.

### TECHNICAL FIELD

The present invention relates to a foamed sheet and a method for producing the same. Specifically, the present invention relates to a foamed sheet in which PTFE (polytetrafluoroethylene) is dispersed with a specific particle size in a thermoplastic resin, and a method for producing the same.

### BACKGROUND ART

Foams made from thermoplastic resins are widely used, through taking advantage of the lightweightness, heat insulating properties and mechanical properties thereof, as heat insulating materials, impact absorbing materials, food containers and the like. In particular, extrusion molded bodies such as films and sheets have excellent features with respect to mechanical properties and optical reflection performance, and hence are promising as materials for various applications as packaging containers for food and daily commodities, packaging materials, building materials, light reflection plates and the like.

In the above-described applications, for the purpose of attaining lightweightness, flexibility, heat insulating properties and light reflection function, there are intensely demanded films and sheets which internally contain extremely fine bubbles of a few ten microns or less.

In particular, in application to reflection plates for large-sized liquid crystal television sets, light reflectivity and shapability are required, for the purpose of improving the brightness and brightness unevenness of displays. Simultaneously, with progressively increasing size of displays, weight reduction and shape retention of sheets are also required.

Examples of the thermoplastic resin foamed sheet that internally contains bubbles include the following.

Patent Document 1 discloses a film in which bubbles are formed by using as nuclei a resin incompatible with polyethylene terephthalate (PET). However, in the aforementioned film, the orientational crystallization of the film is progressed by stretching. This leads to the decrease of the degree of elongation and to the degradation of the shapability of the sheet. Additionally, due to the shape and location of the bubbles, when force is exerted in the direction normal to the sheet surface, the bubbles are readily collapsed, and creases and flaws are formed. Moreover, the disclosed method enables to obtain only thin films.

Patent Document 2 discloses a foam formed by injecting a gas into a PET sheet in a high-pressure vessel, and by thereafter heating the PET sheet so as for the gas to be expanded to generate foams. Specifically, disclosed is a foam which has fine bubbles having an average bubble size of 50 μm or less, and is a thermoplastic polyester foam having a thickness of 200 μm or more and a specific gravity of 0.7 or less. However, when the gas is injected in the high-pressure vessel, the sheet is crystallized to render the shaping thereof difficult. Additionally, a batch process is adopted, and hence the production cost is high.

Further disclosed is an extruded foam board obtained by melt-kneading a mixed resin composed of polypropylene, polystyrene and styrene-isoprene block copolymer, a physical foaming agent (aliphatic hydrocarbons, and halogenated hydrocarbons) and a low-molecular-weight PTFE having a primary particle size of 1 μm or less, and by thereafter pressure extruding the melt-kneaded mixture to form bubbles (see Patent Document 3).

Additionally, disclosed is a thermoplastic resin extruded foam having an average bubble size of 0.4 to 2.2 mm obtained by introducing a hydrocarbon foaming agent under pressure into a thermoplastic resin composition composed of a thermoplastic resin and a PTFE powder having an average particle size of 0.5 μm or more, and by melt-kneading the thus obtained mixture (see, for example, Patent Document 4).

However, the techniques disclosed in Patent Documents 3 and 4 cannot yield foams having such fine bubbles as attained in the present invention.

In Patent Document 5, a foam is obtained by introducing a foaming agent such as butane under pressure into a resin composition, in a molten state, composed of a thermoplastic polyester modified with a cross-linking agent and PTFE and by conducting degassing. However, in the foams obtained by these techniques, the bubbles cannot be miniaturized and hence no sufficient light reflectivity can be attained.

Patent Document 6 discloses a foamed sheet having fine bubbles formed by incorporating a supercritical gas into a thermoplastic resin sheet including a thermoplastic resin and PTFE and by thereafter discharging pressure. However, a polymer PTFE having a molecular weight of 500,000 or more is mixed for the purpose of flame retarding. This polymer is fibrillated at the time of producing the sheet, and hence causes a problem that no sufficient light reflection property can be obtained.

Additionally, no prior art documents offer either any description or any suggestion related to the fact that the amount proportion of FLEE, and the dispersion state of PTFE in the thermoplastic resin composition foam significantly affect the miniaturization of bubbles and additionally the light reflectivity, wherein the aforementioned amount proportion of PTFE and the dispersion state of PTFE are the techniques of the present invention.

Patent Document 1: Japanese Patent No. 3018539

Patent Document 2: Japanese Patent No. 2925745

Patent Document 3: Japanese Patent Laid-Open No. 2001-1878224

Patent Document 4: Japanese Patent Laid-Open No. 2006-77218

Patent Document 5: Japanese Patent Laid-Open No. 09-70871

Patent Document 6: Japanese Patent Laid-Open No. 2003-49018

### DISCLOSURE OF THE INVENTION

### Problems to be Solved by the Invention

An object of the present invention is to provide a foamed sheet having fine bubbles necessary for attaining excellent surface exterior appearance, flexibility, lightweightness, shapability and high light reflectivity. Further, another object of the present invention is to provide a production method which uses common melt-extrusion equipment.

### Means for Solving the Problems

The present inventors conducted a diligent study for the purpose of solving the above-described problems, and consequently discovered that the amount proportion of PTFE and the dispersion state of PTFE in a thermoplastic resin foam significantly affect the miniaturization of bubbles. In other words, the present inventors perfected the present invention by discovering that when PTFE having a specific particle size is dispersed in a specific amount, the bubbles of a foam are miniaturized, and consequently the light reflectance is increased and thus the problems of the present invention are satisfactorily solved.

Specifically, the present invention is as follows.

1. A foamed sheet consisting of a thermoplastic resin composition comprising 80 to 99.5% by weight of an (A) thermoplastic resin and 0.5 to 20% by weight of (B) PTFE (polytetrafluoroethylene), wherein:

when the number of the particles of (B) PTFE having a dispersed particle size falling within a range from 0.05 to 1 μm is represented by (L), the number of the particles of (B) PTFE having a dispersed particle size falling within a range from 1 to 30 μm is represented by (M) and the number of the particles of (B) PTFE having a dispersed particle size falling within a range of 30 μm or more is represented by (N) in the foamed sheet interior observed with a SEM (scanning electron microscope), (L)/(M)=99.99/0.01 to 50/50 and (M)>(N); and

the average bubble size in the direction normal to the take-off direction of the foamed sheet is 0.1 to 50 μm.

2. The foamed sheet according to 1., wherein the apparent density thereof is 0.4 g/cm³ to 0.9 g/cm³.
3. The foamed sheet according to 1. or 2., wherein the average light reflectance thereof in the wavelengths of 450 nm to 700 nm is 80% or more.
4. The foamed sheet according to any one of 1. to 3., wherein the (A) thermoplastic resin is at least one or more resins selected from polyester, polycarbonate, polypropylene, polystyrene and polymethyl methacrylate.
5. The foamed sheet according to 4., wherein the (A) thermoplastic resin is polytrimethylene terephthalate.
6. A method for producing the foamed sheet according to any one of 1. to 5., wherein the foamed sheet is obtained by the steps of: melt-kneading the component including the (A) thermoplastic resin and (B) PTFE with a double screw extruder under the condition of a specific energy of 0.1 to 0.3 kW.Hr/kg; transferring the kneaded mixture into a single screw extruder; injecting a (G) inorganic gas into the kneaded mixture to be mixed therewith, while the kneaded mixture is being in a molten state, in an amount of 0.01% by weight to 0.6% by weight in relation to the thermoplastic resin composition; thereafter extruding the kneaded mixture from a mouthpiece by applying an extrusion pressure of 5 MPa to 100 MPa, wherein the kneaded mixture is molded and at the same time undergoes bubble formation; and then cooling the molded kneaded mixture for solidification to yield the foamed sheet.
7. The method for producing the foamed sheet according to 6., characterized in that the component including the (A) thermoplastic resin and (B) PTFE is dry-blended, and thereafter the blended mixture is transferred into a double screw extruder to be melt-kneaded.
8. The method for producing the foamed sheet according to 6., characterized in that first the (A) thermoplastic resin is melted in the double screw extruder, and thereafter (B) PTFE is added to conduct the melt-kneading.
9. The method for producing the foamed sheet according to 6., characterized in that 1 to 50% by weight of an (E) resin composition including 40 to 95% by weight of the (A) thermoplastic resin and 5 to 60% by weight of (B) PTFE and 99 to 50% by weight of the (A) thermoplastic resin are melt-kneaded in the double screw extruder.
10. The method for producing the foamed sheet according to 6., wherein the gas type of the (G) inorganic gas is nitrogen.
11. The method for producing the foamed sheet according to 6., wherein the average particle size of the primary particles of (B) PTFE is 0.05 to 1 μm.
12. A light reflection plate formed of the foamed sheet according to any one of 1. to 5.

### ADVANTAGES OF THE INVENTION

According to the present invention, there can be obtained a fine foamed sheet formed from the above-described resin composition, having excellent flexibility, lightweightness, surface exterior appearance, shapability and light reflectivity.

### BRIEF DESCRIPTION OF THE DRAWINGS

FIG. 1 is a top view and side views as seen from two viewing directions of a vacuum molding die used in Examples and Comparative Examples; and

FIG. 2 is a view showing the measurement examples of the dispersed particle size of (B) PTFE. The lengthwise length, to be described below, of a particle of (B) PTFE is the longest possible length of the observed particle of PTFE. In this figure, (a), (b) and (c) show the measurement examples of the cases where the particle of PTFE is spherical, fibrillar and irregular, respectively.

### BEST MODES FOR CARRYING OUT THE INVENTION

Hereinafter, the present invention is specifically described.

The (A) thermoplastic resin as referred to in the present invention is not particularly limited as long as the (A) thermoplastic resin is a commonly used thermoplastic resin. Additionally, two or more types of thermoplastic resins may be mixed. Examples of such a thermoplastic resin include: polyesters such as polyethylene terephthalate, polytrimethylene terephthalate, polybutylene terephthalate, polyethylene naphthalate and polytrimethylene naphthalate, and ester copolymers; polyamides such as nylon 6, nylon 11, nylon 12, nylon 66, nylon 46, nylon 610, nylon 612 and nylon MXD 6, and amide copolymers; polyolefins such as low-density polyethylene, high-density polyethylene, medium-density polyethylene, linear low-density polyethylene, polypropylene, polymethylpentene, and ethylene-propylene copolymer; olefin copolymers such as ethylene-vinyl acetate copolymer and ethylene-methacrylic acid ionomer; elastomers such as polybutadiene and polyisoprene; styrene resins such as polystyrene, styrene-acrylonitrile copolymer, styrene-acrylonitrile-butadiene graft copolymer and polyphenylene oxide; acrylic resins such as polymethyl methacrylate and polyethyl acrylate; halogen-containing resins such as vinyl chloride resin and vinylidene chloride resin and halogen-containing copolymers; and polyphenylene sulfide, polypropylene oxide, polycarbonate, polyether ketone, polyether ether ketone, polyacetal and acetal copolymers.

In the present invention, preferable among the thermoplastic resins are polyester, polycarbonate, polypropylene, polystyrene and polymethyl methacrylate, from the viewpoint of mechanical properties, heat resistance, shapability and light reflectance.

As for the type of the polyester, from the viewpoint of the heat resistance, light reflectivity and shapability, preferably used are: polyesters such as polyethylene terephthalate, polytrimethylene terephthalate, polyethylene naphthalate, polytrimethylene naphthalate, polycyclohexanedimethyl terephthalate, polycyclohexanedimethyl naphthalate and polylactic acid; and the copolymers of these.

In the present invention, more preferable among the polyesters are polytrimethylene terephthalate and the copolymers thereof from the viewpoint of the light reflectivity and shapability.

Polytrimethylene terephthalate (hereinafter abbreviated as PTT) as referred to herein means a polyester composed of a trimethylene terephthalate repeating unit in which terephthalic acid is adopted as the acid component and trimethylene glycol (1,3-propanediol; hereinafter, abbreviated as “TMG”) is adopted as the diol component.

PTT can be obtained by means of heretofore known methods. For example, PTT can be obtained by conducting an ester exchange reaction under ordinary pressure at a temperature of 180° C. to 260° C., by using as the raw materials dimethyl terephthalate and TMG, and where necessary, other copolymerization components and by using titanium tetrabutoxide as a catalyst, and by thereafter conducting a polycondensation reaction under reduced pressure at 220° C. to 270° C.

Examples of the monomers to be the copolymerization components include ester-forming monomers such as ethylene glycol, 1,1-propanediol, 1,2-propanediol, 2,2-propanediol, 1,2-butanediol, 1,3-butanediol, 1,4-butanediol, neopentyl glycol, 1,5-pentamethylene glycol, hexamethylene glycol, heptamethylene glycol, octamethylene glycol, decamethylene glycol, dodecamethylene glycol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, 5-sodium sulfoisophthalate, 3,5-dicarboxylic acid benzene sulfonic acid tetramethyl phosphonium salt, isophthalic acid, oxalic acid, succinic acid, adipic acid, dodecane diacid, fumaric acid, maleic acid and 1,4-cyclohexane dicarboxylic acid.

From the viewpoint of the light reflectance and the exterior appearance of the foamed sheet, the proportion of the thermoplastic resin in the foamed sheet is 80% by weight to 99.5% by weight, more preferably 85% by weight to 99% by weight and furthermore preferably 90% by weight to 98% by weight. From the viewpoint of the exterior appearance of the sheet, the proportion of the thermoplastic resin in the foamed sheet is 80% by weight or more. From the viewpoint of the light reflectance, the proportion of the thermoplastic resin in the foamed sheet is 99.5% by weight or less.

In the present invention, a particularly preferable PTT foamed sheet is a foamed sheet 80% by weight to 99.5% by weight of which is formed from PTT. This is because such a sheet has excellent flexibility and shapability. It is conceivable that this originates from the moderate crystallization rate, the molecular structure low in chemical reactivity and the flexibility of the crystal due to the zig-zag molecular skeleton structure, all inherent to PTT.

For the purpose of enhancing the thermal stability at the time of producing the sheet, and the flexibility, light reflectivity and heat resistance of the sheet, the content of the aforementioned copolymerization component is preferably set at 30 mol % or less, more preferably at 20 mol % or less and furthermore preferably at 10 mol % or less.

The polymerization degree of PTT of the present invention preferably falls within a range from 0.5 dl/g to 4 dl/g in terms of the intrinsic viscosity [η] adopted as the index. By setting the intrinsic viscosity at 0.5 dl/g or more, the sheet production is facilitated, and simultaneously the miniaturization of bubble size is also facilitated. On the other hand, by setting the intrinsic viscosity at 4 dVg or less, the sheet production is facilitated. The intrinsic viscosity [η] more preferably falls within a range from 0.7 dVg to 3 dl/g, furthermore preferably within a range from 0.9 dug to 2.5 dl/g and particularly preferably within a range from 1 dl/g to 2 dl/g.

Additionally, in PIT of the present invention, the carboxyl terminal group concentration is preferably 0 eq/ton to 80 eq/ton. By setting the carboxyl terminal group concentration at 80 eq/ton or less, it becomes easy to enhance the weather resistance, chemical resistance, hydrolysis resistance and heat resistance of a sheet and a molded body. The carboxyl terminal group concentration is more preferably 0 eq/ton to 50 eq/ton, furthermore preferably 0 eq/ton to 30 eq/ton and particularly preferably 0 eq/ton to 20 eq/ton; the lower the carboxyl terminal group concentration, the better.

Also because of the same reason, preferably 0% by weight to 2% by weight is the content of the bis(3-hydroxypropyl)ether component (structural formula: —OCH₂CH₂CH₂OCH₂CH₂CH₂O—, hereinafter abbreviated as “BPE”) that is the glycol dimer component formed by two molecules of TMG, which is the glycol component of PTT, bonded to each other through the intermediary of an ether bond; the aforementioned content is more preferably 0.1% by weight to 1.7% by weight and furthermore preferably 0.15% by weight to 1.5% by weight.

The dispersion state of (B) PTFE (polytetrafluoroethylene) of the present invention is required to be such that the particle size of PTFE and the amount of PTFE each fall in a specific range, from the viewpoint of the miniaturization of the bubbles and the improvement of the light reflectance of the foamed sheet. Specifically, when in the foamed sheet interior observed with a SEM (scanning electron microscope), the number of the particles of (B) PTFE having a dispersed particle size falling within a range from 0.05 to 1 μm is represented by (L), the number of the particles of (B) PTFE having a dispersed particle size falling within a range from 1 to 30 μm is represented by (M) and the number of the particles of (B) PTFE having a dispersed particle size falling within a range of 30 μm or more is represented by (N), (L)/(M)=99.99/0.01 to 50/50, and (M)>(N). The dispersed particle size as referred to herein means, as described below, the particle size of PTFE in the foamed sheet observed with a SEM. Preferably, (L)/(M)=99.9/0.1 to 70/30 and (M)>(N), and more preferably, (L)/(M)=99/1 to 90/10 and (M)>(N).

When PTFE is dispersed with a particle size of 1 to 30 μm, offered is an effect to remarkably increase the bubble nuclei, and when dispersed with a particle size of 0.05 to 1 μm, offered is an effect to inhibit the growth of the bubbles. Therefore, by dispersing FIVE with the above-described range, the miniaturization of the bubbles is attained. Moreover, by dispersing PTFE particles with the above-described range in the foamed sheet, the incident light is scattered on the fine bubble interface and the PTFE interface to attain the improvement of the light reflectance.

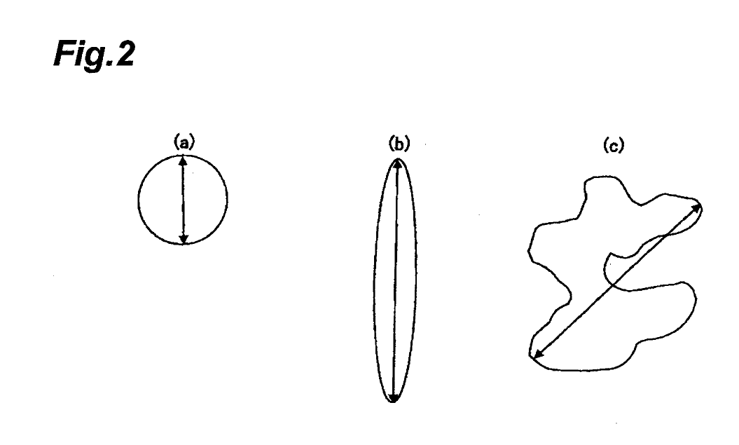

It is to be noted that the above-described dispersed particle size of PTFE means the lengthwise length of a particle of PTFE as observed in the cross section of the foamed sheet under observation with a SEM. A measurement example is shown in FIG. 2.

For the purpose of dispersing (B) PTFE in the foamed sheet so as to meet the above-described range, the particle size of raw material PTFE, in particular, the average particle size of the primary particles thereof is preferably 0.05 to 1 μm and most preferably 0.1 to 0.5 μm, from the viewpoint of the light reflectivity of the foamed sheet. For the measurement of the average particle size of the primary particles, electron microscopic observation or a dynamic light scattering method can be applied. In the present invention, electron microscopic observation was adopted. Additionally, the secondary particles (aggregates of primary particles) have an average particle size as the size at 50 cumulative weight %, as measured by a light transmission method, of preferably 0.3 to 30 μm, more preferably 1 to 20 μm and most preferably 2 to 10 μm.

Low-molecular-weight PTFE is preferably used as (B) PTFE. Low-molecular-weight PTFE means PTFE having a melt viscosity of 2500 Pa·s or less as obtained by measurement with a flow tester method at 340° C. Low-molecular-weight PTFE is low in mechanical strength, and is generally added to polymers and coating materials for the purpose of imparting lubricity and water-repellency. Additionally, low-molecular-weight PTFE is not fibrillated when melt-kneaded with a thermoplastic resin, and the dispersion of low-molecular-weight PTFE with the above-described dispersed particle size in a foamed sheet enables to obtain a foam having fine bubbles that have never hitherto been attained.

Known examples of the method for producing such low-molecular-weight PTFE include: an emulsion polymerization method, a suspension polymerization method, telomerization of tetrafluoroethylene in a solvent, baking of low-molecular-weight PTFE, a thermal decomposition method of high-molecular-weight PTFE and a decomposition method of high-molecular-weight PTFE with radioactive ray. Among these, the emulsion polymerization method and the decomposition method with radioactive ray are most preferable production methods.

The content of PTFE in the foamed sheet of the present invention is required to be 0.5 to 20% by weight from the viewpoint of the light reflection property and the exterior appearance of the sheet. The aforementioned content of PTFE is preferably 2 to 15% by weight and particularly preferably 3 to 10% by weight.

The foamed sheet of the present invention includes the cases where various organic substances, various inorganic substances and various additives are contained in addition to the thermoplastic resin. Even in such cases, the proportion of the thermoplastic resin is required to fall within the above-described range.

Examples of the inorganic substances that can be contained in the foamed sheet of the present invention include: inorganic fillers such as glass fiber, carbon fiber, talc, mica, wallastnite, kaolin clay, calcium carbonate, titanium dioxide and silicon dioxide; inorganic lubricants; and polymerization catalyst residues.

Examples of the additives that can be contained in the foamed sheet of the present invention include: organic and inorganic dyes and pigments, a matting agent, a heat stabilizer, a flame retardant, an antistatic agent, an antifoaming agent, an orthochromatic agent, an antioxidant, an ultraviolet absorber, a crystal nucleating agent, a brightening agent, an impurity trapping agent, a thickening agent and a surface conditioner.

Preferable as the heat stabilizer that can be contained in the foamed sheet of the present invention are a pentavalent phosphorus compound and/or a trivalent phosphorus compound and hindered phenol compounds. The addition amount of the phosphorus compound is preferably 2 ppm to 500 ppm and more preferably 10 ppm to 200 ppm in terms of the weight proportion of the phosphorus element in a powder. Preferable examples of specific compounds include trimethyl phosphite, phosphoric acid, phosphorous acid and tris(2,4-di-tert-butylphenyl) phosphite (such as Irgafos 168 manufactured by Ciba Specialty Chemicals Inc.).

The hindered phenol compound as referred to herein means a phenol derivative with a substituent having steric hindrance at a position adjacent to the phenolic hydroxyl group and is a compound having one or more ester bonds in the molecule thereof. The addition amount of the hindered phenol compound is preferably 0.001% by weight to 1% by weight and more preferably 0.01% by weight to 0.2% by weight in terms of the weight proportion in relation to a powder.

Preferable examples of specific compounds include pentaerythritol-tetrakis [3-(3,5-di-tert-butyl-4-hydroxyphenyl)propionate] (such as Irganox (registered trademark) 1010, manufactured by Ciba Specialty Chemicals Inc.), 1,1,3-tris(2-methyl-4-hydroxy-5-tert-butylphenyl)butane, octadecyl-3-(3,5-di-tert-butyl-4-hydroxyphenyl)propionate (such as Irganox (registered trademark) 1076, manufactured by Ciba Specialty Chemicals Inc.), N,N-hexamethylenebis(3,5-tert-butyl-4-hydroxy-hydrocinnamamide), ethylenebis(oxyethylene)bis[3-(5-tert-butyl-4-hydroxy-m-tolyppropionate] (such as Irganox (registered trademark) 245, manufactured by Ciba Specialty Chemicals Inc.), and N,N-hexane-1,6-diylbis [3-(3,5-di-tert-butyl-4-hydroxyphenylpropionamide) (such as Irganox (registered trademark) 1098, manufactured by Ciba Specialty Chemicals Inc.). Needless to say, it is also a preferable method to use these stabilizers in combination.

Additionally, in the present invention, it is also preferable to add trapping agents for low-molecular-weight volatile impurities. Preferable examples of the trapping agent include: polymers and oligomers of polyamide and polyesteramide; and low-molecular-weight compounds having an amide group or an amine group. The addition amount of the trapping agent is preferably 0.001% by weight to 1% by weight and more preferably 0.01% by weight to 0.2% by weight, in terms of the weight proportion in relation to the (A) thermoplastic resin.

Preferable examples of specific compounds include: polymers such as polyamides such as nylon 6.6, nylon 6 and nylon 4.6 and polymers such as polyethyleneimines; additionally, a reaction product between N-phenylbenzene amine and 2,4,4-trimethylpentene (such as Irganox (registered trademark) 5057, manufactured by Ciba Specialty Chemicals Inc.), and N,N′-hexane-1,6-diylbis[3-(3,5-di-tert-butyl-4-hydroxyphenylpropionamide) (such as Irganox (registered trademark) 1098, manufactured by Ciba Specialty Chemicals Inc.), and 2,6-di-tert-butyl-4-(4,6-bis(octylthio)-1,3,5-tiazin-2-ylamino)phenol (such as Irganox (registered trademark) 565, manufactured by Ciba Specialty Chemicals Inc.). It is also a preferable method to use these stabilizers in combination.

Although these substances include the substances described in relation to the above-described thermoplastic resin, such substances may be properly used according to the intended purposes.

Additionally, from the viewpoint of light reflectivity, the average bubble size in the direction normal to the sheet take-off direction of the foamed sheet of the present invention is 0.1 μm to 50 μm, preferably 0.5 μm to 30 μm, more preferably 1 μm to 20 μm and most preferably 2 μm to 10 μm.

Additionally, from the viewpoint of excellent flexibility and light reflectivity, the above-described average bubble size is preferably 1/10 or less, more preferably 1/50 or less and particularly preferably 1/100 or less of the sheet thickness.

It is to be noted that the above-described average bubble size in the direction normal to the take-off direction of the sheet means the corresponding circle diameter derived from the SEM image of the sheet cross section by using an image analysis software.

In the foamed sheet of the present invention, the apparent density thereof is preferably 0.4 g/cm³ to 0.9 g/cm³ from the viewpoint of miniaturization of the bubbles. The apparent density set at 0.4 g/cm³ or more enables the foamed sheet to be extruded without undergoing bubble breaking at the time of producing the sheet and with the fine bubbles remaining retained therein. The apparent density set at 0.9 g/cm³ or less enables to meet the light reflection performance of the foamed sheet.

The apparent density of the foamed sheet is more preferably 0.5 g/cm³ to 0.8 g/cm³.

The apparent density as referred to herein means a value derived from the weight of the foamed sheet divided by the volume of the foamed sheet when the foamed sheet is dried at 40° C. so as to reach a constant weight value. It is to be noted that the volume is measured by immersing the sheet into water.

The thickness of the foamed sheet of the present invention is preferably 50 μm to 10 mm. The thickness set at 50 μm or more facilitates handling of the sheet, and the thickness set at 10 mm or less facilitates heat molding (shaping). The thickness of the foamed sheet is more preferably 100 μm to 5 mm and furthermore preferably 200 μm to 3 mm. Moreover, from the viewpoint of the self-retention capability and the heat shapability of the foamed sheet, the thickness of the foamed sheet is particularly preferably 500 μm to 2 mm.

Additionally, the foamed sheet of the present invention is such that the average light reflectance of the foamed sheet in the wavelengths of 450 nm to 700 nm is preferably 80% or more, more preferably 85% or more and most preferably 90% or more. By realizing such light reflectance as described above, the foamed sheet is made suitable as a light reflection plate. It is to be noted that the light reflectance as referred to herein means a relative value determined by taking the reflectance of a barium sulfate white plate as 100%. The average light reflectances presented herein are the values measured with a spectrophotometer, and each represent an average value of the total reflectance including the diffuse reflection and the specular reflection.

Next, the method for producing a foamed sheet, according to the present invention, is described.

The method for producing a foamed sheet of the present invention is a method in which an inorganic gas is mixed with a resin composition including a thermoplastic resin and PTFE, and thereafter degassing is conducted. The inorganic gas is probably dissolved in the thermoplastic resin. Specifically, the mixture including the (A) thermoplastic resin and (B) PTFE melt-kneaded with a double screw extruder is transferred into a single screw extruder; a (G) inorganic gas is injected into and mixed with the thermoplastic resin composition, while the kneaded mixture is being in a molten state; thereafter, the kneaded mixture is extruded from a mouthpiece under specific conditions; thus the kneaded mixture is molded and at the same time, undergoes the bubble formation of the injected substance, and is then rapidly cooled for solidification.

The double screw extrusion conditions for obtaining the foamed sheet of the present invention are such that the component including the (A) thermoplastic resin and (B) PTFE is melt-kneaded with a double screw extruder under the condition of a specific energy of preferably 0.1 to 0.3 kW.Hr/kg, more preferably 0.1 to 0.28 kW.Hr/kg and most preferably 0.1 to 0.25 kW.Hr/kg. The specific energy as referred to herein is a numerical value obtained by dividing the consumed electric power required for rotating the screw in the melt-kneading with an extruder by the discharged amount. From the viewpoint of dispersing (B) PTFE within a range specified in the present invention, it is preferable to conduct the melt-kneading within the above-described specific energy range.

Additionally, preferable examples of the method for kneading the (A) thermoplastic resin and (B) PTFE with a double screw extruder, for the purpose of obtaining the foamed sheet of the present invention, include: a method in which the component including the (A) thermoplastic resin and (B) PTFE is dry-blended, and thereafter the blended mixture is transferred into the double screw extruder to be melt-kneaded; a method in which first the (A) thermoplastic resin is melted in the double screw extruder, and thereafter (B) PTFE is added to conduct the melt-kneading; and additionally a method in which 1 to 50% by weight of an (E) resin composition including 40 to 95% by weight of the (A) thermoplastic resin and 5 to 60% by weight of (B) PTFE and 99 to 50% by weight of the (A) thermoplastic resin are melt-kneaded in the double screw extruder. Among these methods, most preferably used is the method the component including the (A) thermoplastic resin and (B) PTFE is dry-blended, and thereafter the blended mixture is transferred into the double screw extruder to be melt-kneaded; in particular, when the component including the (A) thermoplastic resin and (B) PTFE is dry-blended, it is preferable to conduct the blending with a Henschel mixer.

The description that when the kneaded mixture is in a molten state means a case where the temperature of the kneaded mixture is equal to or higher than the melting point thereof when the kneaded mixture is crystalline, or a case where the temperature of the kneaded mixture is equal to or higher than the glass transition point thereof when the kneaded mixture is amorphous.

In the single screw extruder, it is preferable to use a screw that is optimal according to the properties of the thermoplastic resin composition to be applied and the properties of the material gas to be injected. The single screw extruder is preferably set at such a temperature that allows no unmelted matter to remain and additionally, enables to suppress the thermal decomposition of the resin composition.

Between the single screw extruder and the mouthpiece, where necessary, a filter may be disposed to remove foreign matter, a gear pump or the like may be disposed in order to improve the quantitative feeding performance, a static mixer may be disposed in order to improve the dispersibility of the injected substance, and a heat exchange unit may be disposed in order to maintain the temperature at a constant value. In such cases, it is preferable to appropriately select the pressure and/or the temperature in order to prevent a material injected into a portion in the vicinity of such a disposed device as described above from being converted into large bubbles. Also, in such cases where these devices are disposed, it is preferable to set the temperature at such a value that allows no unmelted matter to remain and additionally, enables to suppress the thermal decomposition of the resin composition.

Specific examples of the (G) inorganic gas include: hydrogen, oxygen, nitrogen, carbon dioxide, helium, argon and xenon; and inert compounds such as water. Among these, nitrogen is particularly preferably used from the viewpoint of forming fine bubbles in a sheet.

From the viewpoint of miniaturizing the bubbles and making satisfactory the surface condition of the sheet, the injection amount of the (G) inorganic gas is preferably 0.01% by weight to 0.6% by weight, more preferably 0.02% by weight to 0.4% by weight and most preferably 0.05% by weight to 0.2% by weight, in relation to 100% by weight of the thermoplastic resin composition. From the viewpoint of miniaturizing the bubbles, the injection amount is 0.01% by weight or more. From the viewpoint of both miniaturizing the bubbles and making satisfactory the surface condition of the sheet, the injection amount is 0.6% by weight or less.

The position for the injection may be located in any portion between the single screw extruder and the mouthpiece; the injection in the single screw extruder is preferable because the (G) inorganic gas can be uniformly injected into the molten material.

The mouthpiece through which the molten material is extruded can be appropriately selected according to the intended shape of the sheet; however, for the purpose of obtaining a sheet uniform in thickness, it is preferable to use a linear slit referred to as a T-die and an I-die, or a circular slit referred to as a round die. It is preferable to appropriately design the structure of the mouthpiece in such a way that no bubble breaking is caused within the mouthpiece. Additionally, from the viewpoint of miniaturizing the bubble size in the foamed sheet, the pressure of the molten material at the entrance of the mouthpiece is preferably set at 5 MPa or more, more preferably at 10 MPa or more and most preferably at 13 MPa or more. Although no particular upper limit is imposed on the aforementioned pressure, the extrusion pressure is recommended to be set at 100 MPa or less in view of the structure of the facilities.

The mouthpiece temperature at the time of extrusion is preferably set at a temperature as low as possible within a range ensuring no solidification of the molten material from the viewpoint of attaining the miniaturization of bubbles; for example, when a crystalline resin is used as the (A) component, the mouthpiece temperature is preferably set to fall within a range from the melting point of the resin composition to a temperature higher than the melting point by 30° C., more preferably within a range from the melting point to a temperature higher than the melting point by 20° C., and furthermore preferably within a range from the melting point to a temperature higher than the melting point by 15° C.; the mouthpiece temperature is preferably set at a temperature as low as possible within a range ensuring uniform extrusion of the molten material.

In the production method of the present invention, the molten material molded in a sheet shape and subjected to foaming is then cooled for solidification; in the present invention, the molded sheet is rapidly cooled for solidification so as for the bubble size growth to be suppressed. It is to be noted that the term, rapidly, as used herein means the cooling conducted so as to provide the sheet with the above-described thermal properties of the sheet; specifically, the time elapsed from the extrusion from the mouthpiece to the cooling down to the glass transition temperature of the resin composition or lower is preferably set at 30 seconds or less, more preferably 10 seconds or less, furthermore preferably 5 seconds or less and most preferably 2 seconds or less. When an amorphous sheet is obtained, it is particularly important to cool the sheet rapidly for solidification.

Examples of the method for attaining such cooling for solidification include: a method in which the molten material is brought into contact with a solid object such as a cooling roll or a cooling belt; a method in which the sheet is brought into contact with a liquid object such as water; and a method in which these methods are combined. Most preferable among these methods is a method in which the molten material extruded from a slit-shaped mouthpiece is cast (disposed) on a roll or a belt and then immersed into water to be rapidly cooled for solidification.

The solid object such as a cooling roll or a cooling belt is preferably made of a metal satisfactory in thermal conductivity. When the glass transition temperature of the molten material is represented by Tg, the temperature of the solid object or the liquid object to which the molten material is brought into contact is preferably a temperature lower than Tg by 50° C. to a temperature equal to Tg, more preferably a temperature lower than Tg by 45° C. to a temperature lower than Tg by 5° C. and most preferably a temperature lower than Tg by 40° C. to a temperature lower than Tg by 10° C.

The time elapsed from the extrusion from the mouthpiece to the time of being into contact with the solid or liquid object is preferably set at 0.1 second to 10 seconds, more preferably 0.1 second to 5 seconds and particularly preferably 0.1 second to 2 seconds.

Among the foamed sheets of the present invention, an amorphous sheet can be made to be a shaped foam molded body by heat molding the amorphous sheet.

The shape of the molded body can be appropriately selected according to the intended application. Examples of such shapes include a box shape, a cup shape and a corrugated plate shape. Examples of the method for molding such a molded body include press molding, straight molding, drape molding, plug-assist molding, vacuum molding, vacuum-compressed air molding, compressed air molding and vacuum press molding. More preferable among these are vacuum molding, vacuum-compressed air molding and vacuum press molding.

Additionally, by the above-described heat molding, the foamed sheet of the present invention is made to exhibit effects in brightness improvement and elimination of brightness unevenness, for example, as a light reflection plate for use in a large-sized liquid crystal television set. Additionally, as the reflection plate is increased in size, the reflection sheet is required to have rigidity and dimensional stability; heat shaping enables to shape rib structure, boss structure and the like, the rigidity and the dimensional accuracy of the molded body are remarkably improved, and reduction of the number of components is also enabled.

The present application is based on Japanese Patent Applications filed on Sep. 29, 2006 (Japanese Patent Application Nos. 2006-267290 and 2006-267295), and the contents of these applications are incorporated herein by reference.

### EXAMPLES

Hereinafter, the advantageous effects of the present invention are described in more detail with reference to Examples. However, the present invention is by no means limited to these Examples. It is to be noted that the (A) thermoplastic resin used and (B) PTFE used are as follows.

(Raw Materials)

(A) Thermoplastic Resin

A1: Polytrimethylene terephthalate (PTT); Corterra (registered trademark, manufactured by Shell Chemicals, Inc.) CP513000-0312RC

Intrinsic viscosity [η]=1.30 (dl/g)

It is to be noted that the intrinsic viscosity [η] of PTT was derived as follows: an Ostwald viscometer was used; the ratio ηsp/C of the specific viscosity ηsp, at 35° C. in o-chlorophenol, to the concentration C (g/100 ml) was extrapolated to zero concentration and the following formula was used.

### [Formula 1]

A2: Polyethylene terephthalate (PET); NEH 2050 (manufactured by Unitika Ltd.)

A3: Polycarbonate (PC); Wonderlite PC-110 (registered trademark, manufactured by Chimei-Asahi Corp.)

A4: Low-density polyethylene (LDPE); DFDJ-6775 (manufactured by Nippon Unicar Co., Ltd.)

A5: Polypropylene (PP); E-105GM (manufactured by Prime Polymer Co., Ltd.)

A6: Polystyrene (GPPS); Styron G9401 (registered trademark, manufactured by PS Japan Co., Ltd.)

A7: Polymethyl methacrylate (PMMA); Delpet 80N (registered trademark, manufactured by Asalli Kasei Chemicals Corp.)

(B) (Polytetrafluoroethylene)

B1: Rubron L-5 (registered trademark, manufactured by Daikin Industries, Ltd.); primary particle size: 0.2 μm, secondary particle size: 5 μm

B2: KTL-8F (manufactured by Kitamura Ltd.); primary particle size: 0.3 μm, secondary particle size: 4 μm

B3: Rubron L-2 (registered trademark, manufactured by Daikin Industries, Ltd.); primary particle size: 0.2 μm, secondary particle size: 2 μm

B4: Fulon L-1697 (manufactured by Asahi Glass Co., Ltd.); primary particle size: 13 μm, secondary particle size: 13 μm

B5: KT-400M (manufactured by Kitamura Ltd.); primary particle size: 33 μm, secondary particle size: 33 μm

B6: AD938 (manufactured by Asahi Glass Co., Ltd.); primary particle size: 0.4 μm, secondary particle size: 0.4 μm

B7: KTL-500F (manufactured by Kitamura Ltd.); primary particle size: 0.3 μm, secondary particle size: 0.5 μm

B8: KTL-8N (manufactured by Kitamura Ltd.); primary particle size: 4 μm, secondary particle size: 4 μm

Primary Particle Size of PTFE

The primary particle size of each of the PTFE powders used in Examples and Comparative Examples was obtained by electron microscopic observation. The PTFE particle sizes of the smallest units observed in a 10000 times magnified image (10 μm×10 μm) were all measured, and the average value of the measured values was taken as the primary particle size of the PTFE powder. It is to be noted that when the average particle size of a PTFE powder was 1 μm or more as a result of the electron microscopic observation, the PTFE powder was subjected to a measurement with a light transmission method, and the measurement result obtained as the average particle size derived as the size at 50 cumulative weight % was taken as the primary particle size.

Secondary Particle (Aggregate of Primary Particles) Size of PTFE

The secondary particle size of each of the PTFE powders used in Examples and Comparative Examples was measured with a light transmission method (a particle size distribution analyzer SA-CP3L manufactured by Shimadzu Corp.) and was obtained as the average particle size derived as the size at 50 cumulative weight %.

(C) Heat Stabilizer

C1: Irgafos 168 (manufactured by Ciba Specialty Chemicals Inc.)

C2: Irganox 245 (registered trademark, manufactured by Ciba Specialty Chemicals Inc.)

C3: Irganox 1098 (registered trademark, manufactured by Ciba Specialty Chemicals Inc.)

(Measurement Methods)

The main measured values in Examples and Comparative Examples were measured by the following methods.

(1) Dispersed Particle Size of PTFE in a Foam

For the purpose of determining the dispersed particle size of PTFE in a foamed sheet, the foamed sheet was cut along the direction parallel to the take-off direction of the sheet with a diamond cutter, and the thus prepared cross section was photographed with a SEM in three portions each having a viewing field of 50 μm×50 μm. The number of the PTFE particles falling in the range from 0.05 to 1 μm of the observed PTFE particle size, the number of the PTFE particles falling in the range from 1 to 30 μm and the number of the PTFE particles falling in the range of 30 μm or more were counted from each of the three-portion images, and the averages of these numbers each counted in the three-portion images were represented by (L), (M) and (N), respectively. It is to be noted that the above-described dispersed particle size of PTFE was defined as the lengthwise length of the observed PTFE particle (see FIG. 2). Additionally, the PTFE particles observed to protrude from the field of 50 μm×50 μm were also counted in the case where even the smallest portions of such particles were found within the viewing field.

(2) Sheet Thickness

The thickness of a foamed sheet was obtained by measurement with a thickness (micrometer) meter.

(3) Apparent Density

The apparent density of a foamed sheet was derived from the weight of the foamed sheet divided by the volume of the foamed sheet when the foamed sheet was dried at 40° C. so as to reach a constant value. It is to be noted that the volume was measured by immersing the sheet into water.

(4) Average Bubble Size

The average bubble size of a foamed sheet was derived as follows: the sheet was cut along the direction normal to the take-off direction of the sheet with a diamond cutter; the cross section thus prepared was observed with a SEM to obtain a cross section image (the whole area from the surface layer to the interior), from which the average bubble size was derived as the corresponding circle diameter by using an image analysis software. As the image analysis software, used was Image-Pro Plus ver. 4.0 produced by Planetron, Inc.

(5) Sheet Surface Smoothness

The surface exterior appearance of each of the foamed sheets obtained in Examples and Comparative Examples was observed, and evaluated as follows.

x: Hole formation is found in the sheet.

Δ: Fuzz is formed on the surface or irregularities are formed on the surface, but no hole formation is found.

◯: No fuzz is formed on the surface and no irregularities are formed on the surface, and no hole formation is found.

It is to be noted that the hole formation in the sheet means the formation of through-holes penetrating the sheet from the front side to the back side thereof.

(6) Average Light Reflectance

By using a spectrophotometer UV-2200 manufactured by Shimadzu Corp., in a manner in which the incident angle is deviated by 8°, the total reflectance (specular reflectance+diffuse reflectance) of the foamed sheet in the wavelength range from 450 to 700 nm was measured every 10 nm, and the average total reflectance in the aforementioned wavelength range was derived by calculation. The average total reflectance was measured at 10 mm intervals in the sheet width direction, and the average value of the thus obtained values was derived to be taken as the average light reflectance. In this case, the measurement apparatus was adjusted on the assumption that the light reflectance of a barium sulfate powder was 100%.

(7) Flexibility

A thermoplastic resin composition sheet was folded to 180°, and such a state of being folded was observed, and evaluated as follows.

x: Breaking occurs.

Δ: Cracking occurs on the surface.

◯: Neither breaking nor cracking occurs.

(8) Shapability

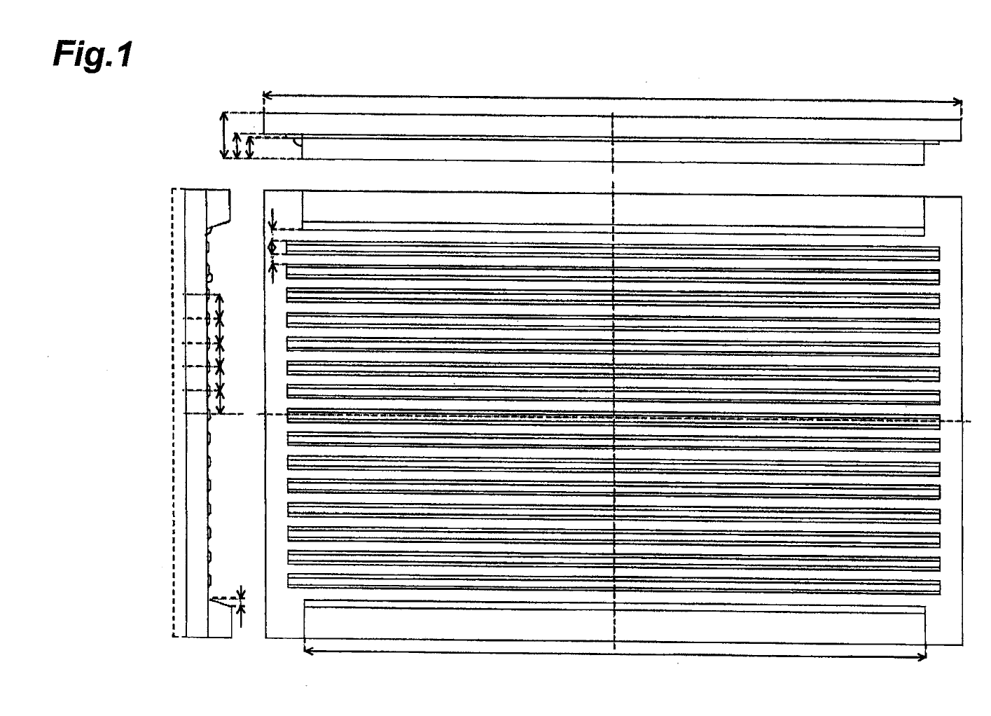

Vacuum-compressed air molding was conducted by using a foamed sheet, with a vacuum molding die shown in FIG. 1, under the conditions described in each of Examples and Comparative Examples, and evaluation was conducted as follows. In the vacuum-compressed air molding, under the described conditions, the heated foamed sheet was brought into contact with the heated die and retained as it was for a predetermined time to be crystallized.

x: Shaping is unsatisfactory.

◯: Shapability is satisfactory.

### (Dispersion Methods)

Dispersion method 1

A method for dispersing (B) PTFE in which: an (A) thermoplastic resin, (B) PTFE and a (C) heat stabilizer are fed in a Henschel mixer and dry-blended; and thereafter, the blended material is fed in a double screw extruder from a feed opening located at an uppermost stream position of the extruder to be melt-kneaded under the condition of a specific energy of 0.1 to 0.3 kW.Hr/kg.

Dispersion Method 2

A method for dispersing (B) PTFE in which: an (A) thermoplastic resin and a (C) heat stabilizer are fed in a double screw extruder from a feed opening located at an uppermost stream position of the extruder, and melted in a first kneading zone; and hereafter, (B) PFTE is fed from a side feeder to be melt-kneaded with the aforementioned molten material under the condition of a specific energy of 0.1 to 0.3 kW.Hr/kg.

Dispersion Method 3

A method for dispersing (B) PTFE in which: an (E) resin composition is obtained by melt-kneading an (A) thermoplastic resin, (B) PTFE and a (C) heat stabilizer; and the (E) resin composition, the (A) thermoplastic resin and the (C) heat stabilizer are further melt-kneaded with a double screw extruder under the condition of a specific energy of 0.1 to 0.3 kW.Hr/kg.

Dispersion Method 4

A method for dispersing (B) PTFE in which: a resin mixture (Y) is obtained by dry-blending an (A) thermoplastic resin and a (C) heat stabilizer; and the resin mixture (Y) and (B) PTFE are fed with separate feeders in a double screw extruder from feed openings located at uppermost stream positions of the extruder to be melt-kneaded under the condition of a specific energy of 0.1 to 0.3 kW.Hr/kg.

Dispersion Method 5

A method for dispersing (B) PTFE in which: an (A) thermoplastic resin, (B) PTFE and a (C) heat stabilizer are fed in a Henschel mixer to be dry-blended; and the blended material is fed in a single screw extruder from a feed opening located at an uppermost stream position of the extruder to be melt-kneaded under the condition of a specific energy of 0.1 to 0.3 kW.Hr/kg.

### Example 1

Raw materials: A1, B1, C1, C2, C3

Dispersion method: Dispersion method 1

Extruder: ZSK-25 double screw extruder

Screw rotation number: 300 rpm, discharge amount: 12 kg/hour, resin temperature at the die exit: 290° C.

The raw materials having the mixing proportions shown in Table 1 were extruded under the above-described conditions to yield a PTT composition having a melting point of 225° C.

The PTT composition was fed into a 90-mmφ single screw extruder set at 235° C. to be melted, then extruded at a linear rate of 10 m/min from a T-die, as a mouthpiece, having a width of 1000 mm and an interval of 0.6 mm, and thus molded into a sheet shape. The flow path from the extruder to the mouthpiece was heated to the same temperature as the temperature of the extruder.

In this case, nitrogen gas in an amount of 0.1% by weight in relation to the composition was injected from a midway position of the extruder, to be mixed with and dissolved in the molten material. The pressure of the molten material at the entrance of the T-die was 15 MPa. The molten material extruded from the T-die was cast on a metal rotating roll separated away by 50 mm from the T-die and thereafter guided into cooling water to be cooled for solidification, and thus a foamed sheet was obtained. In this case, the rotating roll and the cooling water were controlled to be set at 10° C., and the time elapsed from the extrusion to the contact to the rotating roll of the molten material was 0.6 second.

The obtained PTT composition foamed sheet had a thickness of 1.0 mm and a width of 960 mm, and had satisfactory surface exterior appearance. Additionally, the obtained foamed sheet had an apparent density of 0.65 g/cm³, fine bubbles of an average bubble size of 33 μm, a light reflectance of 83%, and satisfactory exterior appearance.

(Vacuum-Compressed Air Molding Conditions)

Molded product size: 630 mm long, 400 mm wide and 25 mm deep

Sheet temperature (heater radiation): 55° C.

Die temperature: 120° C.

Vacuum degree: 720 mmHg

Compression pressure: 0.3 MPa

Retention time: 20 seconds

The obtained molded product was free from breaking and reproduced the die shape.

### Examples 2 to 4

PTT composition foamed sheets and molded products were obtained in the same manner as in Example 1 except that the composition of the raw materials was altered as shown in Table 1 to be presented below. The results thus obtained are shown in Table 1 presented below. In Examples 2, 3 and 4, sheets having particularly fine bubbles were obtained. As can be seen from the apparent density values, these foamed sheets had lightweightness and excellent surface exterior appearance. However, in Example 4, some fuzz occurred on the sheet surface.

### Examples 5 to 7

PTT composition foamed sheets and molded products were obtained in the same manner as in Example 3 except that the amount of nitrogen gas was altered as shown in Table 1 presented below. The results thus obtained are shown in Table 1 presented below. In Examples 5 and 6, sheets having fine bubbles were obtained. As can be seen from the apparent density values, these foamed sheets had lightweightness and excellent surface exterior appearance. However, in Example 7, some fuzz occurred on the sheet surface.

### Examples 8 and 9

In Example 8, a PTT composition foamed sheet and a molded product were obtained in the same manner as in Example 3 except that the extrusion conditions were altered as follows.

Dispersion method: Dispersion method 1

Extruder: ZSK-25 double screw extruder

Screw rotation number: 400 rpm, discharge amount: 16 kg/hour, resin temperature at the die exit: 290° C., specific energy: 0.25 kW.Hr/kg

In Example 9, a PIT composition foamed sheet and a molded product were obtained in the same manner as in Example 3 except that the extrusion conditions were altered as follows.

Dispersion method: Dispersion method 1

Extruder: ZSK-25 double screw extruder

Screw rotation number: 450 rpm, discharge amount: 18 kg/hour, resin temperature at the die exit: 290° C., specific energy: 0.27 kW.Hr/kg

The results thus obtained are shown in Table 1 presented below.

In any case, as can be seen from the apparent density value, the foamed sheet had lightweightness and excellent surface exterior appearance.

### Example 10

Raw materials: A1, B1, C1, C2, C3

Dispersion method: Dispersion method 2

Extruder: ZSK-25 double screw extruder

Screw rotation number: 300 rpm, discharge amount: 12 kg/hour, resin temperature at the die exit: 290° C.

A1, C1, C2 and C3 were dry-blended with a tumbler, and the blended material and B1 were extruded according to the composition shown in Table 1 under the above-described conditions, to yield a PTT composition having a melting point of 225° C.

The PTT composition was fed into a 90-mmφ single screw extruder set at 235° C. to be melted, then extruded at a linear rate of 10 m/min from a T-die, as a mouthpiece, having a width of 1000 mm and an interval of 0.6 mm, and thus molded into a sheet shape. The flow path from the extruder to the mouthpiece was heated to the same temperature as the temperature of the extruder.

The results thus obtained are shown in Table 1 presented below. In any case, as can be seen from the apparent density value, the foamed sheet had lightweightness and excellent surface exterior appearance.

The obtained foamed sheet was subjected to the vacuum-compressed air molding under the same conditions as in Example 1. The obtained molded product was free from breaking and reproduced the die shape.

### Example 11

Raw materials: A1, B1, C1, C2, C3

Dispersion method: Dispersion method 3

Extruder: ZSK-25 double screw extruder

Screw rotation number: 300 rpm, discharge amount: 12 kg/hour, resin temperature at the die exit: 290° C.

A1 in an amount of 83 parts by weight and C1, C2 and C3 each in an amount of 0.1 part by weight were dry-blended with a tumbler, and the blended material and 16.7 parts by weight of the below-described resin composition (E) were extruded under the above-described conditions, to yield a PTT composition having a melting point of 225° C. The PTT composition was fed into a 90-mmφ single screw extruder set at 235° C. to be melted, then extruded at a linear rate of 10 m/min from a T-die, as a mouthpiece, having a width of 1000 mm and an interval of 0.6 mm, and thus molded into a sheet shape. The flow path from the extruder to the mouthpiece was heated to the same temperature as the temperature of the extruder.

Production of the Resin Composition (E)

A1 in an amount of 70 parts by weight, B1 in an amount of 29.7 parts by weight, and C1, C2 and C3 each in an amount of 0.1 part by weight were dry-blended with a tumbler, and the blended material was extruded under the below-described conditions to yield the resin composition (E).

Extruder: ZSK-25 double screw extruder

Screw rotation number: 300 rpm, discharge amount: 12 kg/hour, resin temperature at the die exit: 285° C., specific energy: 0.21 kW.Hr/kg

The results thus obtained are shown in Table 1 presented below. In any case, as can be seen from the apparent density value, the foamed sheet had lightweightness and excellent surface exterior appearance.

The obtained foamed sheet was subjected to the vacuum-compressed air molding under the same conditions as in Example 1. The obtained molded product was free from breaking and reproduced the die shape.

### Example 12

Raw materials: A1, B1, C1, C2, C3

Dispersion method: Dispersion method 4

Extruder: ZSK-25 double screw extruder

Screw rotation number: 300 rpm, discharge amount: 12 kg/hour, resin temperature at the die exit: 290° C.

Under the above-described conditions, 95 parts by weight of the below-described resin composition (Y) and 5.0 parts by weight of B1 were extruded to yield a PTT composition having a melting point of 225° C. The PTT composition was fed into a 90-mmφ single screw extruder set at 235° C. to be melted, then extruded at a linear rate of 10 m/min from a T-die, as a mouthpiece, having a width of 1000 mm and an interval of 0.6 mm, and thus molded into a sheet shape. The flow path from the extruder to the mouthpiece was heated to the same temperature as the temperature of the extruder.

Production of the Resin Composition (Y)

A1 in an amount of 94.7 parts by weight and C1, C2 and C3 each in an amount of 0.1 part by weight were dry-blended with a tumbler.

The results thus obtained are shown in Table 1 presented below. Ad can be seen from the apparent density value, the foamed sheet had lightweightness and excellent surface exterior appearance.

The obtained foamed sheet was subjected to the vacuum-compressed air molding under the same conditions as in Example 1. The obtained molded product was free from breaking and reproduced the die shape.

### Examples 13 and 14

PTT composition foamed sheets and molded products were obtained in the same manner as in Example 3 except that the type of (B) PTFE was altered as shown in Table 1. The results thus obtained are shown in Table 1 presented below. In any case, the PTT composition foamed sheet was found to have excellent lightweightness and excellent surface exterior appearance within the scope of the present invention.

### Examples 15 and 16

PTT composition foamed sheets and molded products were obtained in the same manner as in Example 3 except that the type of the inorganic gas was altered as shown in Table 1. The results thus obtained are shown in Table 1 presented below. In any case, the PTT composition foamed sheet was found to have excellent lightweightness and excellent surface exterior appearance within the scope of the present invention.

### Example 17

Raw materials: A3, B1, C1, C2, C3

Dispersion method: Dispersion method 1

Extruder: ZSK-25 double screw extruder

Screw rotation number: 300 rpm, discharge amount: 12 kg/hour, resin temperature at the die exit: 290° C.

The raw materials having the mixing proportions shown in Table 2 were extruded under the above-described conditions to yield a PC composition.

The PC composition was fed into a 90-mmφ single screw extruder set at 235° C. to be melted, then extruded at a linear rate of 10 m/min from a T-die, as a mouthpiece, having a width of 1000 mm and an interval of 0.6 mm, and thus molded into a sheet shape. The flow path from the extruder to the mouthpiece was heated to the same temperature as the temperature of the extruder.

In this case, nitrogen gas in an amount of 0.1% by weight in relation to the composition was injected from a midway position of the extruder, to be mixed with and dissolved in the molten material. The pressure of the molten material at the entrance of the T-die was 21 MPa. The molten material extruded from the T-die was cast on a metal rotating roll separated away by 50 mm from the T-die and thereafter guided into cooling water to be cooled for solidification, and thus a foamed sheet was obtained. In this case, the rotating roll and the cooling water were controlled to be set at 10° C., and the time elapsed from the extrusion to the contact to the rotating roll of the molten material was 0.6 second.

The obtained PC composition foamed sheet had a thickness of 1.0 mm and a width of 960 mm, and had satisfactory surface exterior appearance. Additionally, the obtained foamed sheet had an apparent density of 0.59 g/cm³, fine bubbles of an average bubble size of 9 μm, a light reflectance of 91%, and satisfactory exterior appearance.

(Vacuum-Compressed Air Molding Conditions)

Molded product size: 630 mm long, 400 mm wide and 25 mm deep

Sheet temperature (heater radiation): 180° C.

Die temperature: 130° C.

Vacuum degree: 720 mmHg

Compression pressure: 0.3 MPa

Retention time: 20 seconds

The obtained molded product was free from breaking and reproduced the die shape. The results thus obtained are shown in Table 2 presented below.

### Example 18

Raw materials: A2, B1, C1, C2, C3

Dispersion method: Dispersion method 1

Extruder: ZSK-25 double screw extruder

Screw rotation number: 300 rpm, discharge amount: 12 kg/hour, resin temperature at the die exit: 305° C.

The raw materials having the mixing proportions shown in Table 3 were extruded under the above-described conditions to yield a PET composition.

The PET resin composition was fed into a 90-mmφ single screw extruder set at 270° C. to be melted, then extruded at a linear rate of 10 m/min from a T-die, as a mouthpiece, having a width of 1000 mm and an interval of 0.6 mm, and thus molded into a sheet shape. The flow path from the extruder to the mouthpiece was heated to the same temperature as the temperature of the extruder.

In this case, nitrogen gas in an amount of 0.1% by weight in relation to the composition was injected from a midway position of the extruder, to be mixed with and dissolved in the molten material. The pressure of the molten material at the entrance of the T-die was 13 MPa. The molten material extruded from the T-die was cast on a metal rotating roll separated away by 50 mm from the T-die and thereafter guided into cooling water to be cooled for solidification, and thus a foamed sheet was obtained. In this case, the rotating roll and the cooling water were controlled to be set at 10° C., and the time elapsed from the extrusion to the contact to the rotating roll of the molten material was 0.6 second.

The obtained PET composition foamed sheet had a thickness of 1.0 mm and a width of 960 mm, and had satisfactory surface exterior appearance. Additionally, the obtained foamed sheet had an apparent density of 0.62 g/cm³, fine bubbles of an average bubble size of 15 μm, a light reflectance of 86%, and satisfactory exterior appearance. The results thus obtained are shown in Table 3 presented below.

(Vacuum-Compressed Air Molding Conditions)

Molded product size: 630 mm long, 400 mm wide and 25 mm deep

Sheet temperature (heater radiation): 90° C.

Die temperature: 150° C.

Vacuum degree: 720 mmHg

Compression pressure: 0.3 MPa

Retention time: 20 seconds

The obtained molded product was free from breaking and reproduced the die shape. The results thus obtained are shown in Table 2 presented below.

### Example 19

Raw materials: A4, B1, C1, C2, C3

Dispersion method: Dispersion method 1

Extruder: ZSK-25 double screw extruder

Screw rotation number: 300 rpm, discharge amount: 12 kg/hour, resin temperature at the die exit: 245° C.

The raw materials having the mixing proportions shown in Table 3 were extruded under the above-described conditions to yield a PET composition. The LDPE resin composition was fed into a 90-mmφ single screw extruder set at 180° C. to be melted, then extruded at a linear rate of 10 m/min from a T-die, as a mouthpiece, having a width of 1000 mm and an interval of 0.6 mm, and thus molded into a sheet shape. The flow path from the extruder to the mouthpiece was heated to the same temperature as the temperature of the extruder.

In this case, nitrogen gas in an amount of 0.1% by weight in relation to the composition was injected from a midway position of the extruder, to be mixed with and dissolved in the molten material. The pressure of the molten material at the entrance of the T-die was 18 MPa. The molten material extruded from the T-die was cast on a metal rotating roll separated away by 50 mm from the T-die and thereafter guided into cooling water to be cooled for solidification, and thus a foamed sheet was obtained. In this case, the rotating roll and the cooling water were controlled to be set at 10° C., and the time elapsed from the extrusion to the contact to the rotating roll of the molten material was 0.6 second.

The obtained LDPE composition foamed sheet had a thickness of 1.0 mm and a width of 960 mm, and had satisfactory surface exterior appearance. Additionally, the obtained foamed sheet had an apparent density of 0.62 g/cm³, fine bubbles of an average bubble size of 18 μm, a light reflectance of 85%, and satisfactory exterior appearance. The results thus obtained are shown in Table 3 presented below.

(Vacuum-Compressed Air Molding Conditions)

Molded product size: 630 mm long, 400 mm wide and 25 mm deep

Sheet temperature (heater radiation): 110° C.

Die temperature: 60° C.

Vacuum degree: 720 mmHg

Compression pressure: 0.3 MPa

Retention time: 20 seconds

The obtained molded product was free from breaking and reproduced the die shape.

### Example 20

Raw materials: A5, B1, C1, C2, C3

Dispersion method: Dispersion method 1

Extruder: ZSK-25 double screw extruder

Screw rotation number: 300 rpm, discharge amount: 12 kg/hour, resin temperature at the die exit: 220° C.

The raw materials having the mixing proportions shown in Table 3 were extruded under the above-described conditions to yield a PP composition. The PP resin composition was fed into a 90-mmφ single screw extruder set at 190° C. to be melted, then extruded at a linear rate of 10 m/min from a T-die, as a mouthpiece, having a width of 1000 mm and an interval of 0.6 mm, and thus molded into a sheet shape. The flow path from the extruder to the mouthpiece was heated to the same temperature as the temperature of the extruder.

In this case, nitrogen gas in an amount of 0.1% by weight in relation to the composition was injected from a midway position of the extruder, to be mixed with and dissolved in the molten material. The pressure of the molten material at the entrance of the T-die was 20 MPa. The molten material extruded from the T-die was cast on a metal rotating roll separated away by 50 mm from the T-die and thereafter guided into cooling water to be cooled for solidification, and thus a foamed sheet was obtained. In this case, the rotating roll and the cooling water were controlled to be set at 10° C., and the time elapsed from the extrusion to the contact to the rotating roll of the molten material was 0.6 second.

The obtained PP composition foamed sheet had a thickness of 1.0 mm and a width of 960 mm, and had satisfactory surface exterior appearance. Additionally, the obtained foamed sheet had an apparent density of 0.55 g/cm³, fine bubbles of an average bubble size of 9 μm, a light reflectance of 91%, and satisfactory exterior appearance. The results thus obtained are shown in Table 3 presented below.

(Vacuum-Compressed Air Molding Conditions)

Molded product size: 630 mm long, 400 mm wide and 25 mm deep

Sheet temperature (heater radiation): 170° C.

Die temperature: 60° C.

Vacuum degree: 720 mmHg

Compression pressure: 0.3 MPa

Retention time: 20 seconds

The obtained molded product was free from breaking and reproduced the die shape.

### Example 21

Raw materials: A6, B1, C1, C2, C3

Dispersion method: Dispersion method 1

Extruder: ZSK-25 double screw extruder

Screw rotation number: 300 rpm, discharge amount: 12 kg/hour, resin temperature at the die exit: 255° C.

The raw materials having the mixing proportions shown in Table 3 were extruded under the above-described conditions to yield a GPPS composition. The GPPS resin composition was fed into a 90-mmφ single screw extruder set at 200° C. to be melted, then extruded at a linear rate of 10 m/min from a T-die, as a mouthpiece, having a width of 1000 mm and an interval of 0.6 mm, and thus molded into a sheet shape. The flow path from the extruder to the mouthpiece was heated to the same temperature as the temperature of the extruder.

In this case, nitrogen gas in an amount of 0.1% by weight in relation to the composition was injected from a midway position of the extruder, to be mixed with and dissolved in the molten material. The pressure of the molten material at the entrance of the T-die was 19 MPa. The molten material extruded from the T-die was cast on a metal rotating roll separated away by 50 mm from the T-die and thereafter guided into cooling water to be cooled for solidification, and thus a foamed sheet was obtained. In this case, the rotating roll and the cooling water were controlled to be set at 10° C., and the time elapsed from the extrusion to the contact to the rotating roll of the molten material was 0.6 second.

The obtained GPPS composition foamed sheet had a thickness of 1.0 mm and a width of 960 mm, and had satisfactory surface exterior appearance. Additionally, the obtained foamed sheet had an apparent density of 0.56 g/cm³, fine bubbles of an average bubble size of 8 μm, a light reflectance of 94%, and satisfactory exterior appearance. The results thus obtained are shown in Table 3 presented below.

(Vacuum-Compressed Air Molding Conditions)

Molded product size: 630 mm long, 400 mm wide and 25 mm deep

Sheet temperature (heater radiation): 110° C.

Die temperature: 60° C.

Vacuum degree: 720 mmHg

Compression pressure: 0.3 MPa

Retention time: 20 seconds

The obtained molded product was free from breaking and reproduced the die shape.

### Example 22

Raw materials: A7, B1, C1, C2, C3

Dispersion method: Dispersion method 1

Extruder: ZSK-25 double screw extruder

Screw rotation number: 300 rpm, discharge amount: 12 kg/hour, resin temperature at the die exit: 270° C.

The raw materials having the mixing proportions shown in Table 3 were extruded under the above-described conditions to yield a PMMA composition. The PMMA resin composition was fed into a 90-mmφ single screw extruder set at 200° C. to be melted, then extruded at a linear rate of 10 m/min from a T-die, as a mouthpiece, having a width of 1000 mm and an interval of 0.6 mm, and thus molded into a sheet shape. The flow path from the extruder to the mouthpiece was heated to the same temperature as the temperature of the extruder.

In this case, nitrogen gas in an amount of 0.1% by weight in relation to the composition was injected from a midway position of the extruder, to be mixed with and dissolved in the molten material. The pressure of the molten material at the entrance of the T-die was 16 MPa. The molten material extruded from the T-die was cast on a metal rotating roll separated away by 50 mm from the T-die and thereafter guided into cooling water to be cooled for solidification, and thus a foamed sheet was obtained. In this case, the rotating roll and the cooling water were controlled to be set at 10° C., and the time elapsed from the extrusion to the contact to the rotating roll of the molten material was 0.6 second.

The obtained PMMA composition foamed sheet had a thickness of 1.0 mm and a width of 960 mm, and had satisfactory surface exterior appearance. Additionally, the obtained foamed sheet had an apparent density of 0.58 g/cm³, fine bubbles of an average bubble size of 8 pin, a light reflectance of 93%, and satisfactory exterior appearance. The results thus obtained are shown in Table 3 presented below.

(Vacuum-Compressed Air Molding Conditions)

Molded product size: 630 mm long, 400 mm wide and 25 mm deep

Sheet temperature (heater radiation): 110° C.

Die temperature: 60° C.

Vacuum degree: 720 mmHg

Compression pressure: 0.3 MPa

Retention time: 20 seconds

The obtained molded product was free from breaking and reproduced the die shape.

### Comparative Example 1

A PTT composition foamed sheet was obtained in the same manner as in Example 3 except that the resin composition was extruded with a ZSK-25 double screw extruder under the conditions that the screw rotation number was 500 rpm, the discharge amount was 20 kg/hour and the specific energy was 0.31 kW.Hr/kg. The results thus obtained are shown in Table 1 presented below. The sheet obtained in Comparative Example 1 had a large average bubble size and a low light reflectance and was unable to meet the properties required by the present invention. Additionally, some fuzz occurred on the sheet surface.

### Comparative Examples 2 to 5

PTT composition foamed sheets and molded products were obtained in the same manner as in Example 3 except that the type of (B) PTFE was altered as shown in Table 1 presented below and only for Comparative Example 2, the specific energy was changed to 0.22 kW.Hr/kg. The results thus obtained are shown in Table 1 presented below. In any cases, the obtained foamed sheets had lightweightness and excellent surface exterior appearance, but had large average bubble sizes and low light reflectances and hence did not to meet the properties required by the present invention. Additionally, in Comparative Example 4, PTFE was found to take fibril-like shape.

### Comparative Example 6

A PTT composition foamed sheet and a molded product were obtained in the same manner as in Example 3 except that the injection amount of nitrogen gas was altered as shown in Table 1 presented below. The results thus obtained are shown in Table 1 presented below. The obtained sheet had a large average bubble size and an unsatisfactory light reflectance. Additionally, fuzz occurred on the sheet surface, and the sheet lacked flexibility and did not meet the properties required by the present invention.

### Comparative Example 7

A PTT composition foamed sheet and a molded product were obtained in the same manner as in Example 3 except that the type of the inorganic gas was altered as shown in Table 1 presented below. The results thus obtained are shown in Table 1 presented below. The obtained sheet had a large average bubble size and an unsatisfactory light reflectance.

### Comparative Example 8

A PTT composition foamed sheet and a molded product were obtained in the same manner as in Example 3 except that the composition of the raw materials and the specific energy were altered as shown in Table 1 presented below. The results thus obtained are shown in Table 1 presented below. The obtained sheet had some fuzz occurring on the surface thereof, lacked flexibility and did not meet the properties required by the present invention.

### Comparative Example 9

Raw materials: A1, B1, C1, C2, C3

Dispersion method: Dispersion method 5

The raw materials were dry-blended with a Henschel mixer according to the composition shown in Table 1. The blended material was fed into a 90-mmφ single screw extruder set at 235° C. to be melted, then extruded at a linear rate of 10 m/min from a T-die, as a mouthpiece, having a width of 1000 mm and an interval of 0.6 mm, and thus molded into a sheet shape. The flow path from the extruder to the mouthpiece was heated to the same temperature as the temperature of the extruder.

In this case, nitrogen gas in an amount of 0.1% by weight in relation to the composition was injected from a midway position of the extruder, to be mixed with and dissolved in the molten material. The pressure of the molten material at the entrance of the T-die was 15 MPa. The molten material extruded from the T-die was cast on a metal rotating roll separated away by 50 mm from the T-die and thereafter guided into cooling water to be cooled for solidification, and thus a foamed sheet was obtained. In this case, the rotating roll and the cooling water were controlled to be set at 10° C., and the time elapsed from the extrusion to the contact to the rotating roll of the molten material was 0.6 second.

The obtained sheet had some fuzz occurring on the surface thereof and an unsatisfactory light reflectance, and did not meet the properties required by the present invention.

The obtained foamed sheet was subjected to the vacuum-compressed air molding under the same conditions as in Example 1. The obtained molded product was free from breaking and reproduced the die shape.

### Comparative Example 10

Raw materials: A3, B1, C1, C2, C3

Dispersion method: Dispersion method 1

Extruder: ZSK-25 double screw extruder

Screw rotation number: 300 rpm, discharge amount: 12 kg/hour, resin temperature at the die exit: 310° C.

The raw materials having the mixing proportions shown in Table 2 were extruded under the above-described conditions to yield a PC composition.

The PC composition was fed into a 90-mmφ single screw extruder set at 250° C. to be melted, then extruded at a linear rate of 10 m/min from a T-die, as a mouthpiece, having a width of 1000 mm and an interval of 0.5 mm, and thus molded into a sheet shape. The flow path from the extruder to the mouthpiece was heated to the same temperature as the temperature of the extruder.

The obtained PC resin sheet was placed in an autoclave (500 mL), and supercritical carbon dioxide was introduced under pressure into the autoclave at room temperature to increase the pressure inside the autoclave to 15 MPa at room temperature. The autoclave was allowed to stand in an oil bath set at 140° C. for 1 hour. Thereafter, the autoclave was immersed in ice water at 0° C., and at the same time, the pressure inside the autoclave was relieved and reduced to atmospheric pressure to yield a foamed sheet. The results thus obtained are shown in Table 2. The obtained foamed sheet had fine bubbles, but the results were such that the bubble size was comparable with that in Example 3 but the reflectance was lower than that in Example 3. Additionally, the obtained foamed sheet underwent irregularities occurring on the sheet surface. In Comparative Example 10, PTFE was found to take fibril-like shape.

The obtained foamed sheet was subjected to the vacuum-compressed air molding under the same conditions as in Example 17. The obtained molded product was free from breaking and reproduced the die shape.

### Comparative Examples 11 and 12

PC composition foamed sheets and molded products were obtained in the same manner as in Comparative Example 10 except that the type of (B) PTFE was altered as shown in Table 2 presented below. The obtained sheets had fine bubbles in the same manner as in Comparative Example 10, but the results were such that the bubble sizes were comparable with that in Example 3 but the reflectances were lower than that in Example 3. Additionally, the obtained foamed sheet underwent irregularities occurring on the sheet surface, and did not meet the properties required by the present invention.

### Comparative Example 13

A PC composition sheet and a molded product were obtained in the same manner as in Comparative Example 10 except that the type of (B) PTFE and the type of the injected gas were altered as shown in Table 2 presented below. The obtained sheet was absolutely free from foam formation and did not meet the properties required by the present invention.

TABLE 1

| | Production conditions | | | | | | | | | | |
|---|---|---|---|---|---|---|---|---|---|---|---|
| | Raw materials | | | | | | Melt-kneading | | Foam formation | | |
| | | | | Primary | Secondary | | conditions | | conditions | | Sheet |
| | (A) | | | particle | particle | Amount | Dispersion | Specific | | Injection | properties |
| | Type | Amount | (B) | size | size | Parts by | method | energy | (G) | amount | Thickness |
| | Parts by weight | | Type | μm | μm | weight | kW · Hr/kg | | Type | wt % | mm |
| Example 1 | A1 | 98.7 | B1 | 0.2 | 5 | 1.0 | 1 | 0.23 | N₂ | 0.1 | 1.0 |
| Example 2 | A1 | 96.7 | B1 | 0.2 | 5 | 3.0 | 1 | 0.23 | N₂ | 0.1 | 1.0 |
| Example 3 | A1 | 94.7 | B1 | 0.2 | 5 | 5.0 | 1 | 0.23 | N₂ | 0.1 | 1.0 |
| Example 4 | A1 | 84.7 | B1 | 0.2 | 5 | 15.0 | 1 | 0.22 | N₂ | 0.1 | 1.0 |
| Example 5 | A1 | 94.7 | B1 | 0.2 | 5 | 5.0 | 1 | 0.23 | N₂ | 0.05 | 1.0 |
| Example 6 | A1 | 94.7 | B1 | 0.2 | 5 | 5.0 | 1 | 0.23 | N₂ | 0.15 | 1.0 |
| Example 7 | A1 | 94.7 | B1 | 0.2 | 5 | 5.0 | 1 | 0.23 | N₂ | 0.25 | 1.0 |
| Example 8 | A1 | 94.7 | B1 | 0.2 | 5 | 5.0 | 1 | 0.25 | N₂ | 0.1 | 1.0 |
| Example 9 | A1 | 94.7 | B1 | 0.2 | 5 | 5.0 | 1 | 0.27 | N₂ | 0.1 | 1.0 |
| Example 10 | A1 | 94.7 | B1 | 0.2 | 5 | 5.0 | 2 | 0.23 | N₂ | 0.1 | 1.0 |
| Example 11 | A1 | 94.7 | B1 | 0.2 | 5 | 5.0 | 3 | 0.22 | N₂ | 0.1 | 1.0 |
| Example 12 | A1 | 94.7 | B1 | 0.2 | 5 | 5.0 | 4 | 0.23 | N₂ | 0.1 | 1.0 |
| Example 13 | A1 | 94.7 | B2 | 0.3 | 4 | 5.0 | 1 | 0.23 | N₂ | 0.1 | 1.0 |
| Example 14 | A1 | 94.7 | B3 | 0.2 | 2 | 5.0 | 1 | 0.23 | N₂ | 0.1 | 1.0 |
| Example 15 | A1 | 94.7 | B1 | 0.2 | 5 | 5.0 | 1 | 0.23 | CO₂ | 0.1 | 1.0 |
| Example 16 | A1 | 94.7 | B1 | 0.2 | 5 | 5.0 | 1 | 0.23 | Ar | 0.1 | 1.0 |
| Comparative Example 1 | A1 | 94.7 | B1 | 0.2 | 5 | 5.0 | 1 | 0.31 | N₂ | 0.1 | 1.0 |
| Comparative Example 2 | A1 | 94.7 | B4 | 13 | 13 | 5.0 | 1 | 0.22 | N₂ | 0.1 | 1.0 |
| Comparative Example 3 | A1 | 94.7 | B5 | 33 | 33 | 5.0 | 1 | 0.23 | N₂ | 0.1 | 1.0 |
| Comparative Example 4 | A1 | 94.7 | B6 | 0.4 | 0.4 | 5.0 | 1 | 0.23 | N₂ | 0.1 | 1.0 |
| Comparative Example 5 | A1 | 94.7 | B7 | 0.3 | 0.5 | 5.0 | 1 | 0.23 | N₂ | 0.1 | 1.0 |
| Comparative Example 6 | A1 | 94.7 | B1 | 0.2 | 5 | 5.0 | 1 | 0.23 | N₂ | 0.7 | 1.0 |
| Comparative Example 7 | A1 | 94.7 | B1 | 0.2 | 5 | 5.0 | 1 | 0.23 | Butane | 0.1 | 1.0 |
| Comparative Example 8 | A1 | 74.7 | B1 | 0.2 | 5 | 25.0 | 1 | 0.21 | N₂ | 0.1 | 1.0 |
| Comparative Example 9 | A1 | 94.7 | B1 | 0.2 | 5 | 5.0 | 5 | 0.23 | N₂ | 0.1 | 1.0 |

| | Sheet properties | | | | | | |
|---|---|---|---|---|---|---|---|
| | Apparent | Average | (L)/(M)/(N) | Average light | | | |
| | density | bubble size | Number of | reflectance | Surface | | |
| | g/cm3 | μm | particles | % | smoothness | Flexibility | Shapability |
| Example 1 | 0.65 | 33 | 52/3/0 | 83 | ◯ | ◯ | ◯ |
| Example 2 | 0.65 | 12 | 162/8/0 | 89 | ◯ | ◯ | ◯ |
| Example 3 | 0.67 | 8 | 280/11/0 | 91 | ◯ | ◯ | ◯ |
| Example 4 | 0.75 | 13 | 721/15/1 | 88 | Δ | ◯ | ◯ |
| Example 5 | 0.76 | 8 | 271/10/0 | 88 | ◯ | ◯ | ◯ |
| Example 6 | 0.55 | 10 | 255/9/0 | 90 | ◯ | ◯ | ◯ |
| Example 7 | 0.42 | 31 | 252/9/0 | 83 | Δ | ◯ | ◯ |
| Example 8 | 0.67 | 11 | 241/8/0 | 90 | ◯ | ◯ | ◯ |
| Example 9 | 0.65 | 17 | 182/5/1 | 86 | ◯ | ◯ | ◯ |
| Example 10 | 0.62 | 9 | 264/11/0 | 91 | ◯ | ◯ | ◯ |
| Example 11 | 0.57 | 9 | 258/10/0 | 91 | ◯ | ◯ | ◯ |
| Example 12 | 0.64 | 48 | 123/2/1 | 80 | ◯ | ◯ | ◯ |
| Example 13 | 0.62 | 14 | 224/6/0 | 88 | ◯ | ◯ | ◯ |
| Example 14 | 0.62 | 7 | 247/13/0 | 93 | ◯ | ◯ | ◯ |
| Example 15 | 0.64 | 22 | 249/10/0 | 84 | ◯ | ◯ | ◯ |
| Example 16 | 0.63 | 18 | 256/11/0 | 86 | ◯ | ◯ | ◯ |
| Comparative Example 1 | 0.65 | 65 | 109/1/2 | 74 | Δ | ◯ | ◯ |
| Comparative Example 2 | 0.62 | 77 | 0/4/2 | 72 | ◯ | ◯ | ◯ |
| Comparative Example 3 | 0.62 | 110 | 0/0/2 | 69 | ◯ | ◯ | ◯ |
| Comparative Example 4 | 0.65 | 62 | 0/0/9 Fibril | 74 | ◯ | ◯ | ◯ |
| Comparative Example 5 | 0.62 | 53 | 282/0/0 | 78 | ◯ | ◯ | ◯ |
| Comparative Example 6 | 0.95 | 85 | 258/8/0 | 68 | X | X | ⊚ |
| Comparative Example 7 | 0.59 | 720 | 264/9/0 | 45 | ◯ | ◯ | ◯ |
| Comparative Example 8 | 0.91 | 53 | 1201/16/2 | 68 | X | X | ◯ |
| Comparative Example 9 | 0.62 | 58 | 221/1/2 | 78 | X | ◯ | ◯ |

Except for Example 11, the mixing amount of each of C1, C2 and C3 was 0.1 part by weight.

TABLE 2

| | Production conditions | | | | | | | | | | |
|---|---|---|---|---|---|---|---|---|---|---|---|
| | | | | | | | Melt-kneading | | Foam formation | | |
| | Raw materials | | | | | | conditions | | conditions | | |
| | | Amount | | Primary | Secondary | Amount | | Specific | | | Injection |
| | (A) | Parts by | (B) | particle size | particle size | Parts by | Dispersion | energy | Production | (G) | amount |
| | Type | weight | Type | μm | μm | weight | method | kW · Hr/kg | method | Type | wt % |
| Example 17 | A3 | 94.7 | B1 | 0.2 | 5 | 5.0 | 1 | 0.25 | Extrusion | N₂ | 0.1 |
| Comparative | A3 | 94.7 | B6 | 0.4 | 0.4 | 5.0 | 1 | 0.25 | Batch | CO₂ | Injection |
| Example 10 | | | | | | | | | | | under gas |
| | | | | | | | | | | | pressure |
| | | | | | | | | | | | of |
| | | | | | | | | | | | 15 MPa |
| Comparative | A3 | 94.7 | B7 | 0.3 | 0.5 | 5.0 | 1 | 0.25 | Batch | CO₂ | Injection |
| Example 11 | | | | | | | | | | | under gas |
| | | | | | | | | | | | pressure |
| | | | | | | | | | | | of |
| | | | | | | | | | | | 15 MPa |
| Comparative | A3 | 94.7 | B8 | 4 | 4 | 5.0 | 1 | 0.25 | Batch | CO₂ | Injection |
| Example 12 | | | | | | | | | | | under gas |
| | | | | | | | | | | | pressure |
| | | | | | | | | | | | of |
| | | | | | | | | | | | 15 MPa |
| Comparative | A3 | 94.7 | B1 | 0.2 | 5 | 5.0 | 1 | 0.25 | Batch | N₂ | Injection |
| Example 13 | | | | | | | | | | | under gas |
| | | | | | | | | | | | pressure |
| | | | | | | | | | | | of |
| | | | | | | | | | | | 15 MPa |

| | Sheet properties | | | | | | | |
|---|---|---|---|---|---|---|---|---|
| | | | | | Average | | | |
| | | Apparent | Average | (L)/(M)/(N) | light | | | |
| | Thickness | density | bubble size | Number of | reflectance | Surface | | |
| | mm | g/cm3 | μm | particles | % | smoothness | Flexibility | Shapability |
| Example 17 | 1.0 | 0.59 | 9 | 271/9/0 | 91 | ◯ | ◯ | ◯ |
| Comparative | 1.0 | 0.59 | 8 | 0/0/9 | 83 | X | ◯ | ◯ |
| Example 10 | | | | Fibril | | | | |
| Comparative | 1.0 | 0.60 | 8 | 245/0/0 | 81 | X | ◯ | ◯ |
| Example 11 | | | | | | | | |
| Comparative | 1.0 | 0.57 | 9 | 0/10/0 | 82 | X | ◯ | ◯ |
| Example 12 | | | | | | | | |
| Comparative | 1.0 | 1.22 | No foam | 262/8/0 | 34 | ◯ | ◯ | ◯ |
| Example 13 | | | formation | | | | | |

The mixing amount of each of C1, C2 and C3 was 0.1 part by weight.

TABLE 3

| | Production conditions | | | | | | | | | |
|---|---|---|---|---|---|---|---|---|---|---|
| | | | | | | | Melt-kneading | | Foam formation | |
| | Raw materials | | | | | | conditions | | conditions | |
| | | Amount | | Primary | Secondary | Amount | | Specific | | Injection |
| | (A) | Parts by | (B) | particle size | particle size | Parts by | Dispersion | energy | (G) | amount |
| | Type | weight | Type | μm | μm | weight | method | kW · Hr/kg | Type | wt % |
| Example | A2 | 94.7 | B1 | 0.2 | 5 | 5.0 | 1 | 0.22 | N₂ | 0.1 |
| 18 | | | | | | | | | | |
| Example | A4 | 94.7 | B1 | 0.2 | 5 | 5.0 | 1 | 0.24 | N₂ | 0.1 |
| 19 | | | | | | | | | | |
| Example | A5 | 94.7 | B1 | 0.2 | 5 | 5.0 | 1 | 0.25 | N₂ | 0.1 |
| 20 | | | | | | | | | | |
| Example | A6 | 94.7 | B1 | 0.2 | 5 | 5.0 | 1 | 0.23 | N₂ | 0.1 |
| 21 | | | | | | | | | | |
| Example | A7 | 94.7 | B1 | 0.2 | 5 | 5.0 | 1 | 0.22 | N₂ | 0.1 |
| 22 | | | | | | | | | | |

| | Sheet properties | | | | | | | |
|---|---|---|---|---|---|---|---|---|
| | | | | | Average | | | |
| | | Apparent | Average | (L)/(M)/(N) | light | | | |
| | Thickness | density | bubble size | Number of | reflectance | Surface | | |
| | mm | g/cm3 | μm | particles | % | smoothness | Flexibility | Shapability |
| Example | 1.0 | 0.62 | 16 | 241/8/0 | 86 | ◯ | ◯ | ◯ |
| 18 | | | | | | | | |
| Example | 1.0 | 0.62 | 18 | 244/7/0 | 85 | ◯ | ◯ | ◯ |
| 19 | | | | | | | | |
| Example | 1.0 | 0.55 | 9 | 238/9/0 | 91 | ◯ | ◯ | ◯ |
| 20 | | | | | | | | |
| Example | 1.0 | 0.56 | 8 | 251/10/0 | 94 | ◯ | Δ | ◯ |
| 21 | | | | | | | | |
| Example | 1.0 | 0.58 | 8 | 243/9/0 | 93 | ◯ | Δ | ◯ |
| 22 | | | | | | | | |

The mixing amount of each of C1, C2 and C3 was 0.1 part by weight.

### INDUSTRIAL APPLICABILITY

The foamed sheet of the present invention has excellent surface exterior appearance, heat insulating property, lightweightness and light reflectivity. Accordingly, the foamed sheet of the present invention is useful in various applications including advantageous application examples such as food containers, packaging materials, building materials and light reflection plates.

1. A foamed sheet consisting of a thermoplastic resin composition comprising 80 to 99.5% by weight of an (A) thermoplastic resin and 0.5 to 20% by weight of (B) PTFE (polytetrafluoroethylene), wherein:
when the number of the particles of (B) PTFE having a dispersed particle size falling within a range from 0.05 to 1 μm is represented by (L), the number of the particles of (B) FIFE having a dispersed particle size falling within a range from 1 to 30 μm is represented by (M) and the number of the particles of (B) PTFE having a dispersed particle size falling within a range of 30 μm or more is represented by (N) in the foamed sheet interior observed with a SEM (scanning electron microscope), (L)/(M)=99.99/0.01 to 50/50 and (M)>(N); and
the average bubble size in the direction normal to the take-off direction of the foamed sheet is 0.1 to 50 μm.

2. The foamed sheet according to claim 1, wherein the apparent density thereof is 0.4 g/cm³ to 0.9 g/cm³.

3. The foamed sheet according to claim 1 or 2, wherein the average light reflectance thereof in the wavelengths of 450 nm to 700 nm is 80% or more.

4. The foamed sheet according to any one of claims 1 to 3, wherein the (A) thermoplastic resin is at least one or more resins selected from polyester, polycarbonate, polypropylene, polystyrene and polymethyl methacrylate.

5. The foamed sheet according to claim 4, wherein the (A) thermoplastic resin is polytrimethylene terephthalate.

6. A method for producing the foamed sheet according to any one of claims 1 to 5, wherein the foamed sheet is obtained by the steps of:
melt-kneading the component comprising the (A) thermoplastic resin and (B) PTFE with a double screw extruder under the condition of a specific energy of 0.1 to 0.3 kW.Hr/kg;
transferring the kneaded mixture into a single screw extruder;
injecting a (G) inorganic gas into the kneaded mixture to be mixed therewith, while the kneaded mixture is being in a molten state, in an amount of 0.01% by weight to 0.6% by weight in relation to the thermoplastic resin composition;
thereafter extruding the kneaded mixture from a mouthpiece by applying an extrusion pressure of 5 MPa to 100 MPa, wherein the kneaded mixture is molded and at the same time, undergoes bubble formation; and
then cooling the molded kneaded mixture for solidification to yield the foamed sheet.

7. The method for producing the foamed sheet according to claim 6, characterized in that the component comprising the (A) thermoplastic resin and (B) PTFE is dry-blended, and thereafter the blended mixture is transferred into a double screw extruder to be melt-kneaded.

8. The method for producing the foamed sheet according to claim 6, characterized in that first the (A) thermoplastic resin is melted in the double screw extruder, and thereafter (B) PTFE is added to conduct the melt-kneading.

9. The method for producing the foamed sheet according to claim 6, characterized in that 1 to 50% by weight of an (E) resin composition including 40 to 95% by weight of the (A) thermoplastic resin and 5 to 60% by weight of (B) PTFE and 99 to 50% by weight of the (A) thermoplastic resin are melt-kneaded in the double screw extruder.

10. The method for producing the foamed sheet according to claim 6, wherein the gas type of the (G) inorganic gas is nitrogen.

11. The method for producing the foamed sheet according to claim 6, wherein the average particle size of the primary particles of (B) PTFE is 0.05 to 1 μm.

12. A light reflection plate formed of the foamed sheet according to any one of claims 1 to 5.
